(19) United States
(12) Patent Application Publication
(10) Pub. No.: US 2010/0085349 A1
(43) Pub. Date: Apr. 8, 2010

(54) DISPLAY DEVICE

(75) Inventors: Naruhiko KASAI, Yokohama (JP); Masato Ishii, Tokyo (JP); Tohru Kohno, Kokubunji (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/571,536

(22) Filed: Oct. 1, 2009

(30) Foreign Application Priority Data
Oct. 3, 2008 (JP) 2008-258038

(51) Int. Cl. G09G 5/00

(52) U.S. Cl. 345/214

(57) ABSTRACT

Provided is a display device capable of freely setting correction based on a state of a luminance gradient in a self-emission display device for eliminating the luminance gradient. The display device includes: a data line drive circuit for outputting emission control signals for controlling light emission of display elements during a retrace period during which display signal voltages are not output; and an emission power supply circuit for supplying power supply voltages for the light emission of the display elements to power supply lines from at least one of external sides of a display region corresponding to a group including the display elements. The data line drive circuit generates and outputs the emission control signals different among data lines.

### CROSS-REFERENCE TO RELATED APPLICATION

The present application claims priority from Japanese application JP2008-258038 filed on Oct. 3, 2008, the content of which is hereby incorporated by reference into this application.

### BACKGROUND OF THE INVENTION

1. Field of the Invention

The present invention relates to a display device including a self-emission element such as an electroluminescence (EL) element, an organic EL element, or another self-emission type display element.

2. Description of the Related Art

In a display device in which a plurality of self-emission elements each typified by an electroluminescence (EL) element or an organic EL element are arranged in matrix, power supply voltages for generating light from the respective self-emission elements are normally collectively supplied from the outside.

However, when a voltage is to be supplied to each pixel in a panel, the voltage is dropped by a wiring resistance. The voltage drop is recognized by human eyes as a “luminance gradient” phenomenon in which luminance reduces at a position far away from a power supply portion.

In order to correct the “luminance gradient”, a technology of providing a voltage of the self-emission element on an anode electrode side with a gradient opposite to the luminance gradient is disclosed in JP 2005-003837 A.

The technology disclosed in JP 2005-003837 A requires an additional variable power supply. The technology may be applied to a case where the luminance gradient is linear in the lateral direction, but does not take into account a case where a central region becomes bright (or dark) and a case where the luminance gradient is nonlinear (for example, quadratic function).

### SUMMARY OF THE INVENTION

The present invention has been made in view of the problem described above, and therefore it is an object of the present invention to provide drive means capable of freely setting correction particularly based on the state of the luminance gradient in a self-emission display device for eliminating the “luminance gradient”.

A display device according to an aspect of the present invention includes: a plurality of display elements arranged in matrix; a plurality of data lines for supplying display signal voltages to the plurality of display elements; a plurality of scan lines intersecting with the plurality of data lines; a plurality of power supply lines intersecting with the plurality of scan lines; a data line drive circuit for outputting emission control voltages for controlling light emission of the plurality of display elements during a retrace period during which the display signal voltages are not output; and an emission power supply circuit for supplying power supply voltages for the light emission of the plurality of display elements to the plurality of power supply lines from at least one of external sides of a display region corresponding to a group including the plurality of display elements, in which the data line drive circuit generates and outputs the emission control voltages different among the plurality of data lines.

Further, a display device according to another aspect of the present invention includes: a plurality of display elements arranged in matrix; a plurality of data lines for supplying display signal voltages to the plurality of display elements; a plurality of scan lines intersecting with the plurality of data lines; a plurality of power supply lines intersecting with the plurality of scan lines; a data line drive circuit for outputting emission control voltages for controlling light emission of the plurality of display elements during a retrace period during which the display signal voltages are not output; and an emission power supply circuit for supplying power supply voltages for the light emission of the plurality of display elements to the plurality of power supply lines from at least one of external sides of a display region corresponding to a group including the plurality of display elements, in which the data line drive circuit generates and outputs the emission control voltages which are emission control voltages for eliminating a luminance gradient of the plurality of display elements in an arrangement direction of the plurality of power supply lines and which are different among the plurality of data lines.

Further, A display device according to a further aspect of the present invention includes: a plurality of display elements arranged in matrix; a plurality of data lines for supplying display signal voltages to the plurality of display elements; a plurality of scan lines intersecting with the plurality of data lines; a plurality of power supply lines intersecting with the plurality of scan lines; a data line drive circuit for outputting emission control voltages for controlling light emission of the plurality of display elements during a retrace period during which the display signal voltages are not output; an emission power supply circuit for supplying power supply voltages for the light emission of the plurality of display elements to the plurality of power supply lines from at least one of external sides of a display region corresponding to a group including the plurality of display elements; and luminance gradient identification means for identifying a luminance gradient caused by a voltage drop of the plurality of power supply lines, in which the data line drive circuit generates and outputs the emission control voltages different among the plurality of data lines so as to eliminate the luminance gradient of the plurality of display elements, which is identified by the luminance gradient identification means.

According to the present invention, the luminance gradient in the lateral direction which depends on the display state may be corrected.

Other effects of the present invention become apparent from the description of the entirety of the specification.

### BRIEF DESCRIPTION OF THE DRAWINGS

In the accompanying drawings:

FIG. 1 is an explanatory diagram illustrating a schematic structure of a self-emission element display device which is an example of a display device according to a first embodiment of the present invention;

FIG. 2 illustrates an example of an internal structure of a self-emission element display illustrated in FIG. 1;

FIG. 3 illustrates setting of a reference voltage for a signal voltage in a drive inverter illustrated in FIG. 2;

FIG. 4 illustrates a signal voltage write operation and a turn-on time control operation performed by using a triangular wave in the self-emission element display device according to the first embodiment of the present invention;

FIG. 5 illustrates an example of a connection between the internal structure of the self-emission element display illustrated in FIG. 2 and peripheral circuits illustrated in FIG. 1, in particular, a connection with drive voltage generation means;

FIG. 6 illustrates an example of an internal structure of frame storage means and retrace period output control internal data line drive means illustrated in FIG. 1;

FIG. 7 illustrates an example of an internal structure of frame storage and triangular wave data latch means illustrated in FIG. 6;

FIG. 8 illustrates operations of the frame storage means and retrace period output control internal data line drive means illustrated in FIG. 5, and of frame storage means and triangular wave line latch means illustrated in FIG. 7;

FIG. 9 illustrates operations of the frame storage means and retrace period output control internal data line drive means illustrated in FIG. 5 and of triangular wave data shift means illustrated in FIG. 7;

FIG. 10 illustrates a luminance gradient correction operation based on triangular wave control during the signal voltage write operation and the turn-on time control operation performed by using the triangular wave in the self-emission element display device according to the first embodiment of the present invention;

FIGS. 11A to 11D illustrate a concept of luminance gradient correction during white display in the self-emission element display device according to the first embodiment of the present invention;

FIGS. 12A to 12D illustrate a concept of the luminance gradient correction during white display in a case where a luminance gradient characteristic is different (nonlinear) in the self-emission element display device according to the first embodiment of the present invention;

FIG. 13 illustrates a signal voltage write operation and a turn-on time control operation performed by using a rectangular wave in a self-emission element display device according to a second embodiment of the present invention;

FIG. 14 illustrates an example of an internal structure of frame storage means and retrace period output control internal data line drive means in the self-emission element display device according to the second embodiment of the present invention;

FIG. 15 illustrates an example of an internal structure of frame storage and rectangular wave data latch means illustrated in FIG. 14;

FIG. 16 illustrates operations of the frame storage means and retrace period output control internal data line drive means, of frame storage means, and of rectangular wave line latch means in the self-emission element display device according to the second embodiment of the present invention;

FIG. 17 illustrates operations of the frame storage means and retrace period output control internal data line drive means and of rectangular wave data shift means in the self-emission element display device according to the second embodiment of the present invention; and

FIG. 18 illustrates a luminance gradient correction operation based on rectangular wave control during the signal voltage write operation and the turn-on time control operation performed by using the rectangular wave in the self-emission element display device according to the second embodiment of the present invention.

### DETAILED DESCRIPTION OF THE INVENTION

Hereinafter, embodiments of the present invention are described with reference to the accompanying drawings. In the following embodiments, the same constituent elements are denoted by the same reference numerals and the duplicated description thereof is omitted.

### First Embodiment

Hereinafter, a first embodiment of the present invention is described in detail with reference to the accompanying drawings.

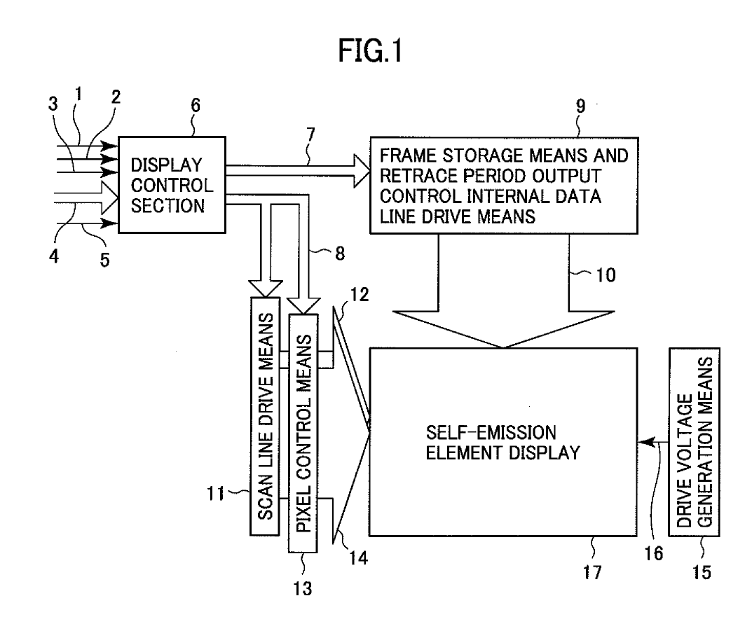

FIG. 1 is an explanatory diagram illustrating a schematic structure of a self-emission element display device, which is an example of a display device according to the first embodiment of the present invention. In FIG. 1, reference numeral 1 denotes a vertical synchronizing signal, 2 denotes a horizontal synchronizing signal, 3 denotes a data enable signal, 4 denotes display data, and 5 denotes a synchronizing clock 5. The vertical synchronizing signal 1 is a one-display frame period (one-frame period) signal, the horizontal synchronizing signal 2 is a one-horizontal period signal, the data enable signal 3 is a signal indicating a valid period (display valid period) of the display data 4. The signals are input in synchronization with the synchronizing clock 5. The first embodiment of the present invention described below is based on the assumption that the sequential transfer of the display data 4 corresponding to one frame in the raster scan form is started from a pixel located at an upper left edge of a screen and information corresponding to one pixel includes 6-bit digital data.

Reference numeral 6 denotes a display control section, 7 denotes data line control signals, and 8 denotes scan line control signals. The display control section 6 generates the data line control signals 7 and the scan line control signals 8 which are used for display control, based on the vertical synchronizing signal 1, the horizontal synchronizing signal 2, the data enable signal 3, the display data 4, and the synchronizing clock 5.

Reference numeral 9 denotes frame storage means and retrace period output control internal data line drive means (data line drive circuit) and 10 denotes data line drive signals. The frame storage means and retrace period output control internal data line drive means 9 generates, based on the data line control signals 7, signal voltages (display signal voltages) to be written into pixels each including a self-emission element (described later in detail) and triangular wave signals (emission control signals) (described later in detail), and outputs the signal voltages and the triangular wave signals as the data line drive signals 10.

Reference numeral 11 denotes scan line drive means, 12 denotes scan line selection signals, 13 denotes pixel control means, 14 denotes data write control signals, 15 denotes drive voltage generation means (emission power supply circuit), 16 denotes a self-emission element drive voltage, and 17 denotes a self-emission element display. The self-emission element display 17 is a display which uses a light emitting diode or an organic EL element as a display element. The self-emission element display 17 includes a plurality of self-emission elements (pixel portion) arranged in matrix. The following description is made based on the assumption that the self-emission elements each serving as the display element are formed in matrix and a region related to actual display is a display region.

The drive voltage generation means 15 generates a power supply voltage for supplying a current to emit light from the self-emission elements (described later in detail), and outputs the power supply voltage as the self-emission element drive voltage 16. During the display operation of the self-emission element display 17, data are written into pixels which are selected and write-controlled in response to the scan line drive signals 12 output from the scan line drive means 11, based on the signal voltages corresponding to the data line drive signals 10 output from the frame storage means and retrace period output control internal data line drive means 9. The display operation of the self-emission element display 17 is also performed based on the triangular wave signals. The voltage for driving the self-emission elements is supplied as the self-emission element drive voltage 16. Note that each of the frame storage means and retrace period output control internal data line drive means 9, the scan line drive means 11, and the pixel control means 13 each may be realized with a large scale integrated (LSI) circuit. The frame storage means and retrace period output control internal data line drive means 9, the scan line drive means 11, and the pixel control means 13 may be realized with a single LSI circuit. Further, the frame storage means and retrace period output control internal data line drive means 9, the scan line drive means 11, and the pixel control means 13 may be formed on the same glass substrate as the pixel portion.

The first embodiment of the present invention described below is based on the assumption that the self-emission element display 17 has a resolution of 240×320 dots and each of the dot includes three pixels of red (R), green (G), and blue (B) which are arranged in this order from the left, that is, 720 pixels are provided in the lateral direction of the self-emission element display.

In the self-emission element display 17, the luminance of light emitted from each of the self-emission elements may be adjusted based on the amount of current flowing into the self-emission element and a turn-on time of the self-emission element. The luminance of the self-emission element becomes higher as the amount of current flowing into the self-emission element increases. The luminance of the self-emission element becomes higher as the turn-on time of the self-emission element lengthens. The resolution of the self-emission element display 17 is not limited to 240×320 dots, and another resolution may be set. In this case, the number of data lines, the number of scan lines, and the number of write control lines, which are described later, are adjusted as appropriate based on the set resolution.

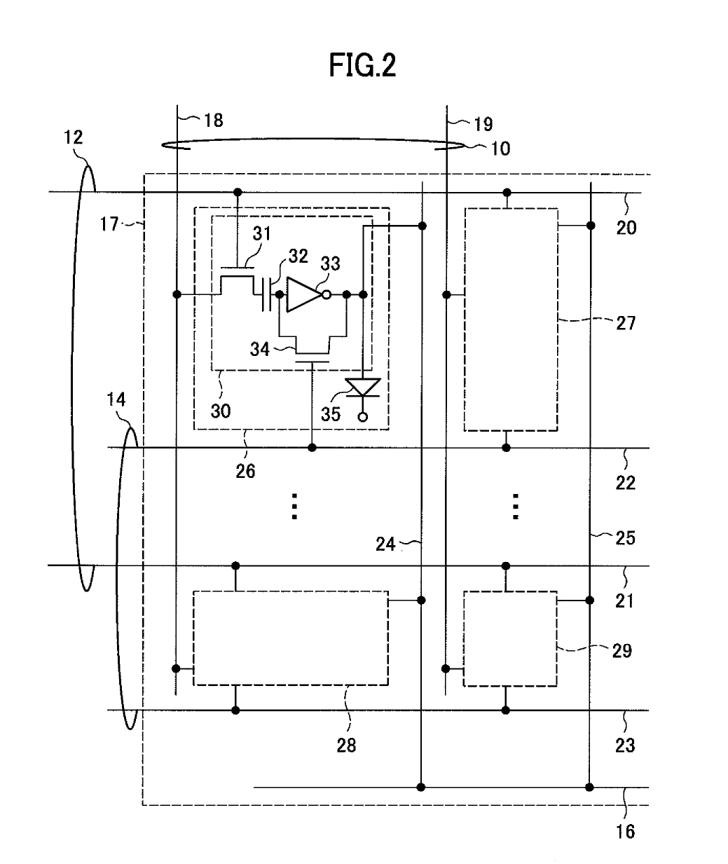

FIG. 2 illustrates an example of an internal structure of the self-emission element display 17 illustrated in FIG. 1. In this example, an organic EL element is used as the self-emission element. Note that the self-emission element is not limited to the organic EL element, and an inorganic EL element or a light emitting diode may also be used.

In FIG. 2, reference numeral 18 denotes a first data line, 19 denotes a second data line, 20 denotes a first scan line, 21 denotes a 320th scan line, 22 denotes a first write control line, 23 denotes a 320th write control line, 24 denotes a first-column organic EL drive voltage supply line, 25 denotes a second-column organic EL drive voltage supply line, 26 denotes a first-row first-column pixel, 27 denotes a first-row second-column pixel, 28 denotes a 320th-row first-column pixel, and 29 denotes a 320th-row second-column pixel. The signal voltages and the triangular waves are supplied through the data lines to the pixels of the rows selected through the scan lines and write control lines, and the turn-on times of the pixels turned on in response to organic EL drive voltages supplied from the organic EL drive voltage supply lines of the respective columns are controlled based on the signal voltages and the triangular waves. With respect to the internal structure of the pixel, only the first-row first-column pixel 26 is illustrated. However, each of the first-row second-column pixel 27, the 320th-row first-column pixel 28, and the 320th-row second-column pixel 29 also has the same structure as the first-row first-column pixel 26.

In FIG. 2, reference numeral 30 denotes a pixel drive section, 31 denotes a switching transistor, 32 denotes a write capacitor, 33 denotes a drive inverter, 34 denotes a write control switch, and 35 denotes an organic EL element. The pixel drive section 30 controls the turn-on time of the organic EL element 35 based on the signal voltage. The pixel drive section 30 includes the switching transistor 31, the write capacitor 32, the drive inverter 33, and the write control switch 34. The switching transistor 31 is turned on through the first scan line 20. The write control switch 34 is turned on through the first write control line 22. When the write control switch 34 is turned on, the input and output terminals of the drive inverter 33 are short-circuited, to thereby set a reference voltage corresponding to characteristics of a transistor serving as the drive inverter 33 of each of the pixels. The signal voltage from the first data line 18 is stored in the write capacitor 32 based on the reference voltage. When the triangular wave input after writing is higher than the signal voltage stored in the write capacitor 32, the drive inverter 33 turns off the organic EL element 35. When the triangular wave input after writing is lower than the signal voltage stored in the write capacitor 32, the drive inverter 33 turns on the organic EL element 35. Therefore, the turn-on time of the organic EL element 35 is controlled according to the signal voltage. As described above, the number of pixels of the self-emission element display 17 is 240×320. Thus, the 320 scan lines extending in the lateral direction are the first scan line 20 to the 320th scan line 21 which are arranged side by side (in parallel with one another) in the longitudinal direction, and the 720 data lines extending in the longitudinal direction are the first data line 18 and the second data line 19 to a 720th data line which are arranged side by side (in parallel with one another) in the lateral direction.

As described above, in the first embodiment of the present invention, each of the plurality of scan lines and each of the plurality of data lines are formed so as to intersect with each other. The pixels are arranged in the regions surrounded by the scan lines and the data lines. A line for the self-emission element drive voltage 16 is provided on the lower side of the self-emission element display 17 in the lateral direction.

Hereinafter, the description is made based on the assumption that, in order to supply the power supply voltages to the respective self-emission elements, the lines (for example, the first-column organic EL drive voltage supply line 24 and the second-column organic EL drive voltage supply line 25) extending in the longitudinal direction (column direction) are arranged in parallel with each other in the lateral direction (row direction) and each of the organic EL drive voltage supply lines is connected to the 720 data lines (drive voltage supply lines). Note that the drive voltage supply lines intersect with the scan lines.

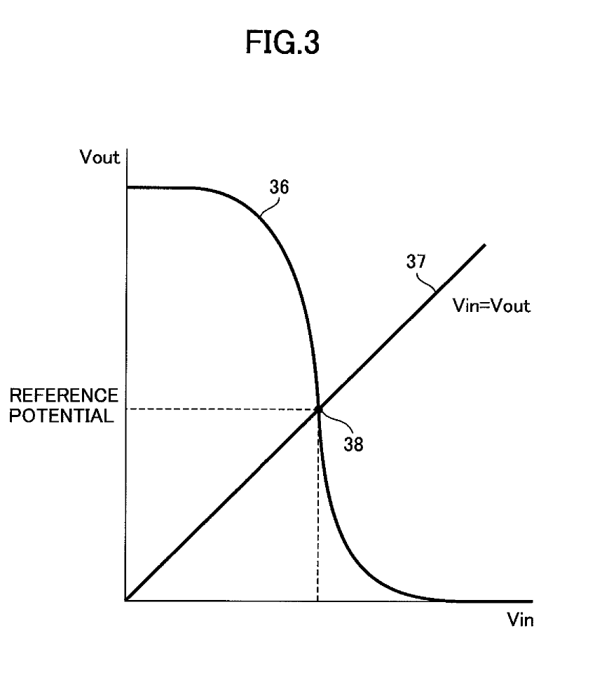

FIG. 3 illustrates setting of the reference voltage for the signal voltage in the drive inverter 33 illustrated in FIG. 2. In FIG. 3, reference numeral 36 denotes an input and output characteristic of the drive inverter 33, 37 denotes an input and output short circuit condition, and 38 denotes a signal voltage write reference potential (reference voltage) in the drive inverter 33. At the time of data writing, the input and output terminals of the drive inverter 33 are short-circuited, and hence the potential of the input and output terminals becomes the signal voltage write reference potential 38 which corresponds to an intersection between the input and output characteristic 36 and the input and output short circuit condition 37 expressed by a linear line of Vin=Vout. The signal voltage is written based on the signal voltage write reference voltage 38.

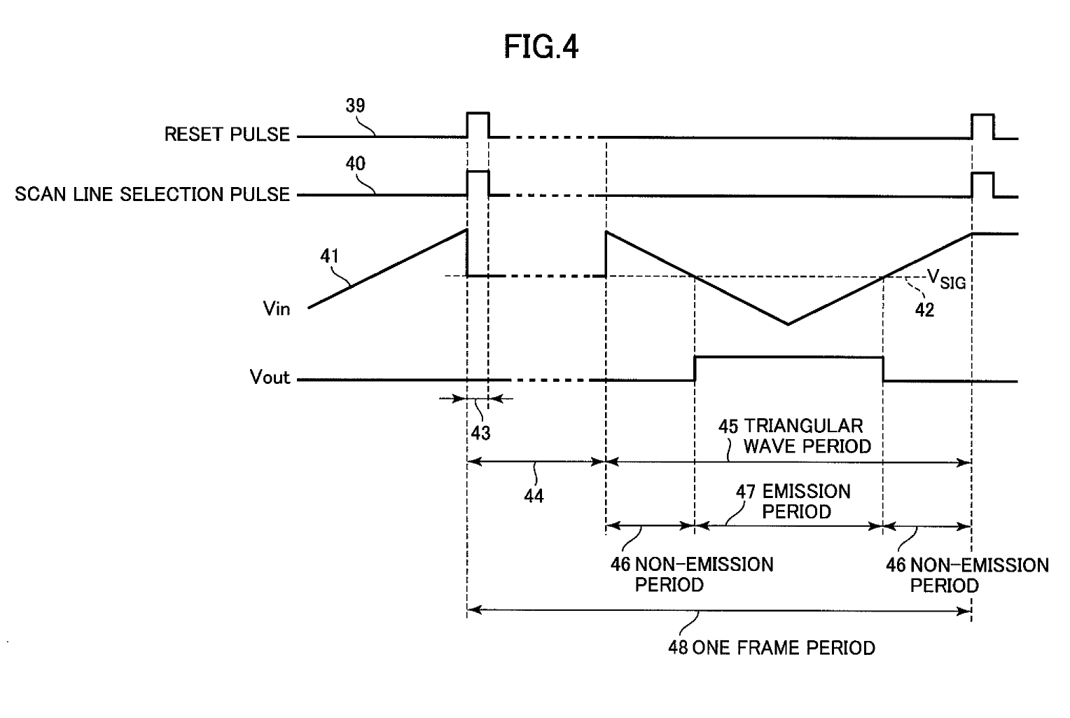

FIG. 4 illustrates a signal voltage write operation and a turn-on time control operation performed by using the triangular wave. In FIG. 4, reference numeral 39 denotes a write control pulse (reset pulse), 40 denotes a scan line selection pulse, 41 denotes a drive inverter input (Vin), 42 denotes a drive inverter threshold voltage, 43 denotes a data write period corresponding to one line, 44 denotes a data write period corresponding to 320 lines, 45 denotes a triangular wave period, 46 denotes non-emission periods, 47 denotes an emission period, and 48 denotes one frame period.

The write control pulse 39 is used to turn on the write control switch 34 illustrated in FIG. 2, to thereby set the signal voltage write reference voltage 38 illustrated in FIG. 3. The scan line selection pulse 40 is used to turn on the switching transistor 31 illustrated in FIG. 2 simultaneously with the setting of the signal voltage write reference voltage 38 by the write control pulse 39, to thereby write the signal voltage into the write capacitor 32 through the drive inverter input 41 based on the signal voltage write reference voltage 38. A potential V_{SIG} written into the write capacitor 32 is the drive inverter threshold voltage 42 which is the threshold voltage of the drive inverter 33.

The drive inverter input 41 exhibits an input waveform of a certain drive inverter. Each of the other drive inverters provided on the same scan line also receives an input of a signal voltage based on display data at a corresponding position within a period of the data write period 43 corresponding to one line. Signal voltages for the other scan lines are written during the other periods of the data write period 44.

After the completion of the data write period 44, the drive inverter input 41 is set to the triangular wave during the triangular wave period 45. During a period in which the level of the triangular wave exceeds the drive inverter threshold voltage 42, the output of the drive inverter 33 is “0”. During a period in which the level of the triangular wave is smaller than the drive inverter threshold voltage 42, the output of the drive inverter 33 is “1”. Therefore, during the non-emission periods 46, the power supply to the organic EL element 35 is in an “off state”. In addition, during the emission period 47, the power supply to the organic EL element 35 is in an “on state”. Thus, the emission period based on the signal voltage is determined. Note that the data input and the triangular wave input are performed at predetermined intervals. The first embodiment of the present invention described below is based on the assumption that the data input and the triangular wave input are performed during the one frame period 48 corresponding to a frequency of 60 [Hz].

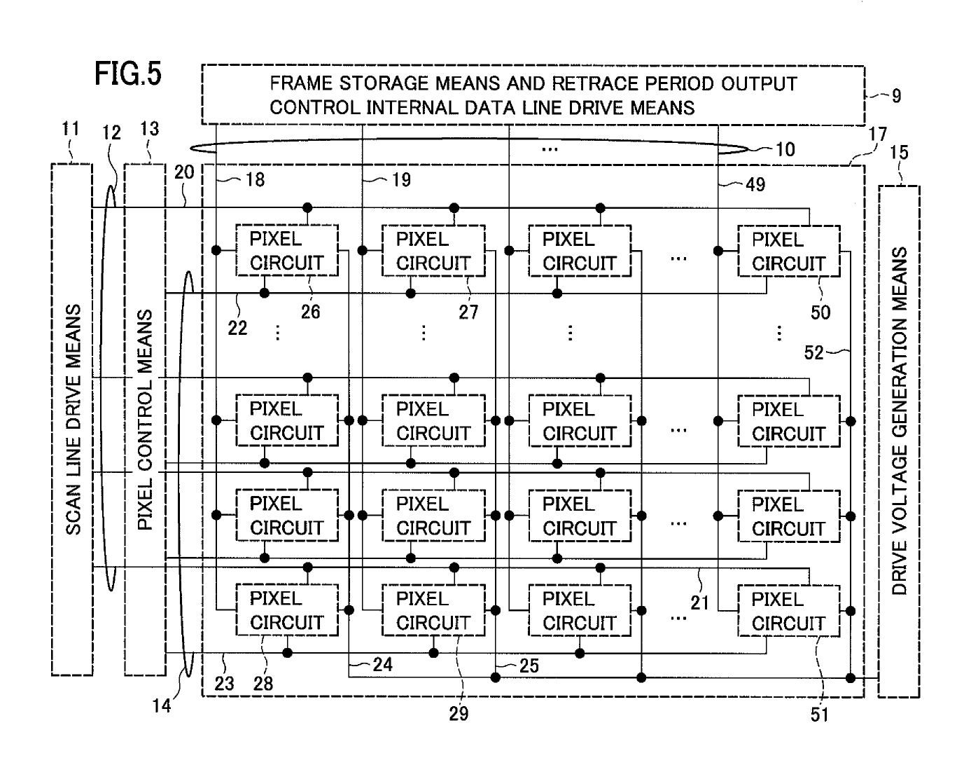

FIG. 5 illustrates an example of a connection between the internal structure of the self-emission element display 17 illustrated in FIG. 2 and the peripheral circuits illustrated in FIG. 1 (particularly, connection with drive voltage generation means 15). In FIG. 5, reference numeral 49 denotes a 720th data line, 50 denotes a first-row 720th-column pixel (circuit), 51 denotes a 320th-row 720th-column pixel (circuit), and 52 denotes a 720th-column organic EL drive voltage supply line. The line for the self-emission element drive voltage 16 is provided on the lower side of a panel, extended in the lateral direction from the right lower side to the left lower side, and connected to the respective organic EL drive voltage supply lines 24, 25, and 52.

In the first embodiment of the present invention, the wiring for the self-emission element drive voltage 16 has a relatively high resistance, and hence the wiring of each of the organic EL drive voltage supply lines 24, 25, and 52 has a low resistance. Therefore, the following description is made based on the assumption that a luminance gradient is provided such that the luminance reduces from right to left in the lateral direction.

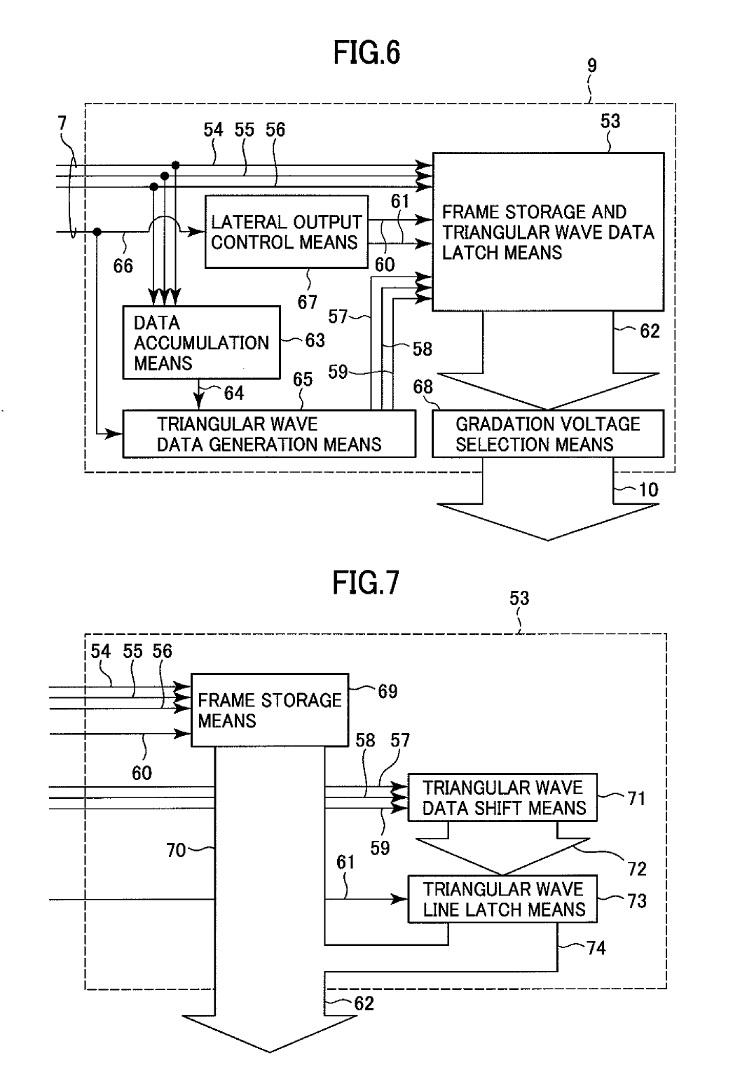

FIG. 6 illustrates an example of an internal structure of the frame storage means and retrace period output control internal data line drive means 9 illustrated in FIG. 1. In FIG. 6, reference numeral 53 denotes frame storage and triangular wave data latch means, 54 denotes a data start signal, 55 denotes a data clock, 56 denotes display input serial data, 57 denotes a triangular wave start signal, 58 denotes a triangular wave clock, 59 denotes triangular wave serial data, 60 denotes a lateral data readout pulse, 61 denotes a triangular wave lateral latch pulse, and 62 denotes one-line data.

The frame storage and triangular wave data latch means 53 operates in synchronization with the data clock 55, and captures the display input serial data 56 corresponding to one line during one horizontal period based on the data start signal 54 used as a capture start reference. Then, the frame storage and triangular wave data latch means 53 causes storage means (described later) to temporarily store the captured display input serial data 56 corresponding to one line, and collectively reads out one-line display data pieces (described later in detail) corresponding to one lateral line in synchronization with the lateral data readout pulse 60. The frame storage and triangular wave data latch means 53 operates in synchronization with the triangular wave clock 58, captures the triangular wave serial data 59 corresponding to one line during one horizontal period based on the triangular wave start signal 57 used as the capture start reference, and outputs one-line triangular wave data (described later in detail) in synchronization with the triangular wave lateral latch pulse 61. Then, the frame storage and triangular wave data latch means 53 combines the one-line display data pieces corresponding to one lateral line which are collectively read out in synchronization with the lateral data readout pulse 60 and the one-line triangular wave data output in synchronization with the triangular wave lateral latch pulse 61, and outputs the resultant data as the one-line data 62.

Reference numeral 63 denotes data accumulation means (luminance gradient identification means) and 64 denotes luminance gradient information. The data accumulation means 63 identifies a display luminance at each lateral position and accumulates the display luminance from a frame edge. When the display luminance is accumulated from the frame edge in the data accumulation means 63, the voltage drop of the self-emission element drive voltage 16 from the frame edge in the lateral direction may be estimated, and hence such information is output as the luminance gradient information 64.

Reference numeral 65 denotes triangular wave data generation means and 66 denotes a lateral output timing. The triangular wave data generation means 65 counts the lateral output timing 66 to identify a triangular wave output timing, and then generates the triangular wave start signal 57, the triangular wave clock 58, and the triangular wave serial data 59. At this time, the triangular wave data generation means 65 generates a triangular wave having a triangular wave period and level which correspond to a gradient opposite to the luminance gradient information 64, based on a lateral position and the luminance gradient information 64.

Lateral output control means 67 counts the lateral output timing 66 to identify whether the counted lateral output timing is a display data output timing or a triangular wave output timing. The lateral output control means 67 generates the lateral data readout pulse 60 at the display data output timing, and generates the triangular wave lateral latch pulse 61 at the triangular wave output timing. Gradation voltage selection means 68 selects a gradation voltage having one of 64 gradation levels based on the one-line data 62 and outputs the selected gradation voltage as the data line drive signal 10. In other words, the gradation voltage selection means 68 performs digital/analog conversion. The conversion is performed using a method similar to the conventional method.

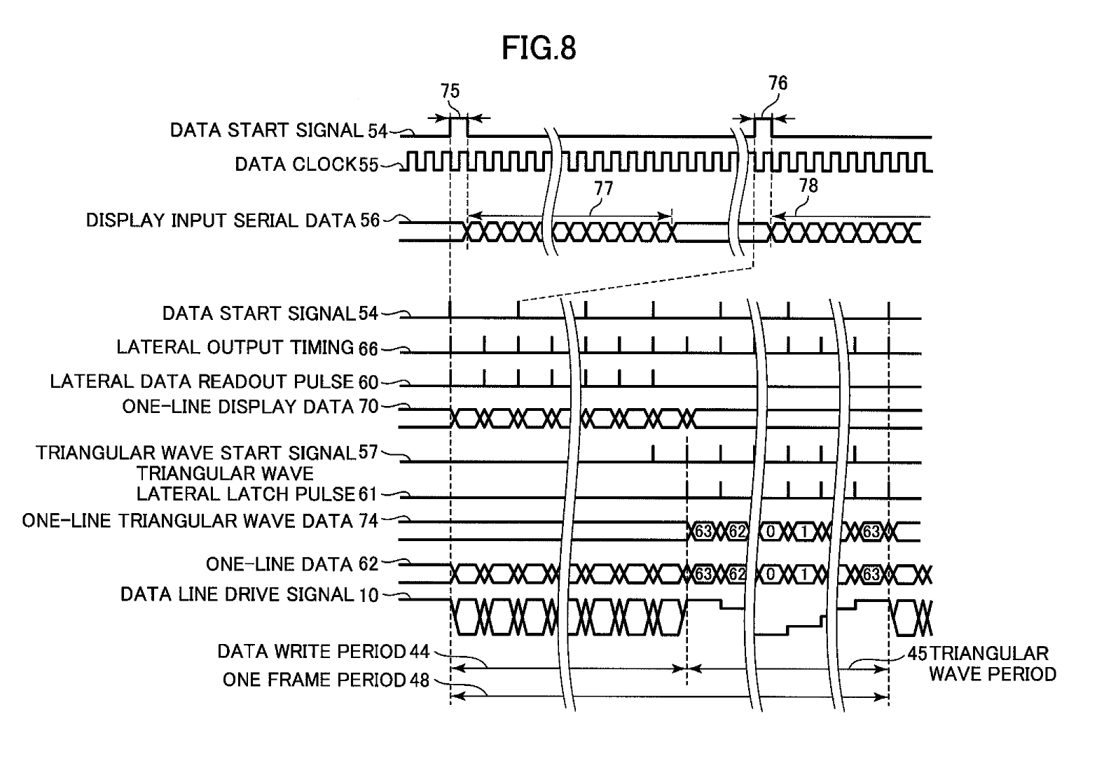

FIG. 7 illustrates an example of an internal structure of the frame storage and triangular wave data latch means 53 illustrated in FIG. 6. In FIG. 7, reference numeral 69 denotes frame storage means and 70 denotes one-line display data. The frame storage means 69 stores the display input serial data 56 bit by bit based on the data start signal 54 and the data clock 55. The frame storage means 69 collectively reads out data pieces corresponding to one lateral line in synchronization with the lateral data readout pulse 60, and outputs the data as the one-line display data 70.

Reference numeral 71 denotes triangular wave data shift means and 72 denotes triangular wave shift data. The triangular wave data shift means 71 operates in synchronization with the triangular wave clock 58 and captures the triangular wave serial data 59 corresponding to one line during one horizontal period based on the triangular wave start signal 57 used as the capture start reference. The captured triangular wave serial data is output as the triangular wave shift data 72.

Reference numeral 73 denotes triangular wave line latch means and 74 denotes one-line triangular wave data. The triangular wave line latch means 73 latches the triangular wave shift data 72 corresponding to one line and outputs the latched triangular wave shift data as the one-line triangular wave data 74 in synchronization with the triangular wave lateral latch pulse 61. The one-line display data 70 and the one-line triangular wave data 74 are combined for each output data line and output as the one-line data 62. In other words, in the first embodiment of the present invention, the display data output period is not overlapped with the triangular wave output period (described later in detail).

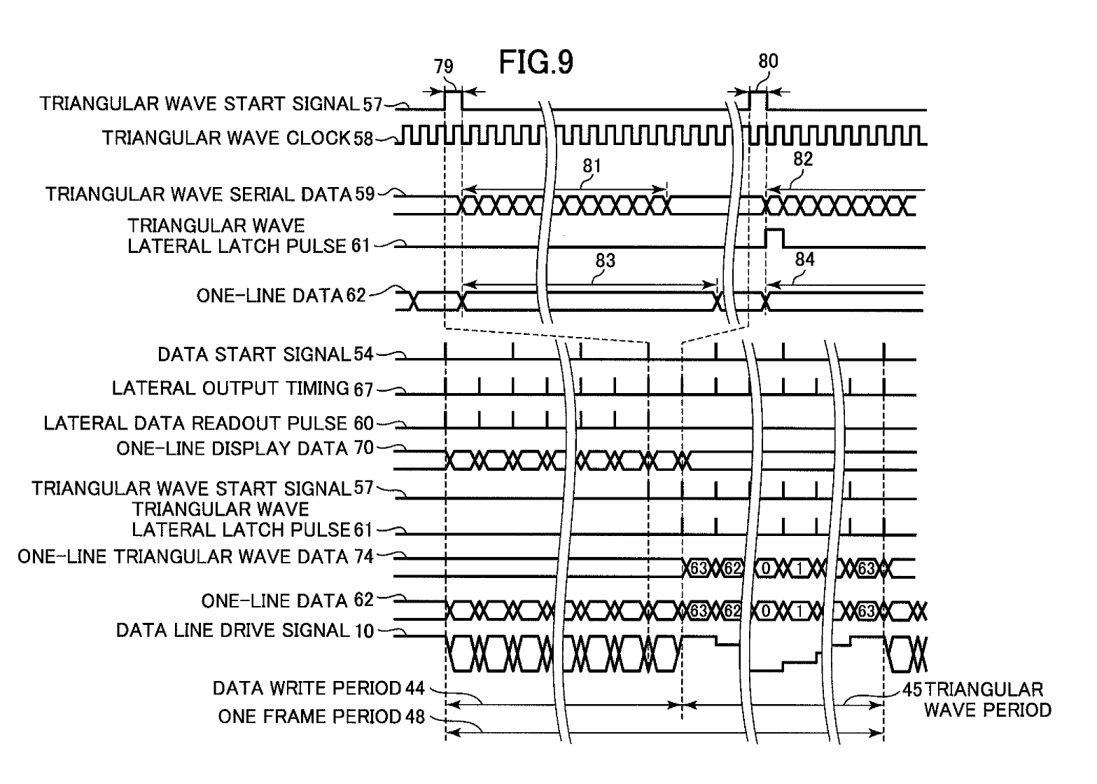

FIG. 8 illustrates operations of the frame storage means and retrace period output control internal data line drive means 9 illustrated in FIG. 5, and of the frame storage means 69 and the triangular wave line latch means 73 illustrated in FIG. 7. In FIG. 8, reference numeral 75 denotes an n-th-line data start timing, 76 denotes an (n+1)-th-line data start timing, 77 denotes n-th-line display input serial data, and 78 denotes (n+1)-th-line display input serial data. The display input serial data 56 is captured in synchronization with the data clock 55 based on a timing when the data start signal 54 is “1” and temporarily stored in the frame storage means described above. For example, the n-th-line display input serial data 77 is captured from the rising edge of the data clock 55 which follows the n-th-line data start timing 75 and temporarily stored in the frame storage means. FIG. 8 also illustrates the time axis which is extended. The temporarily-stored display input serial data pieces corresponding to one lateral line are collectively readout in synchronization with the lateral data readout pulse 60 within the data write period 44. The first embodiment of the present invention described below is based on the assumption that, in order to shorten the data write period and lengthen the triangular wave period, display data pieces corresponding to one frame are temporarily stored such that the lateral data readout pulse 60 which is a readout timing is higher in frequency (two times higher in this embodiment) than the data start signal 54.

The triangular wave start signal 57 is output during the triangular wave period 45 which starts at the same timing as the final lateral data readout pulse 60 and is obtained by subtracting the data write period 44 from the one frame period 48. The triangular wave lateral latch pulse 61 is output for a line next to a line for which the triangular wave start signal 57 starts to be output. Therefore, the one-line display data 70 is output as the one-line data 62 during the data write period 44. The one-line triangular wave data 74 is output as the one-line data 62 during the triangular wave period 45. Lastly, the data line drive signal 10 is obtained by performing analog conversion on the one-line data 62.

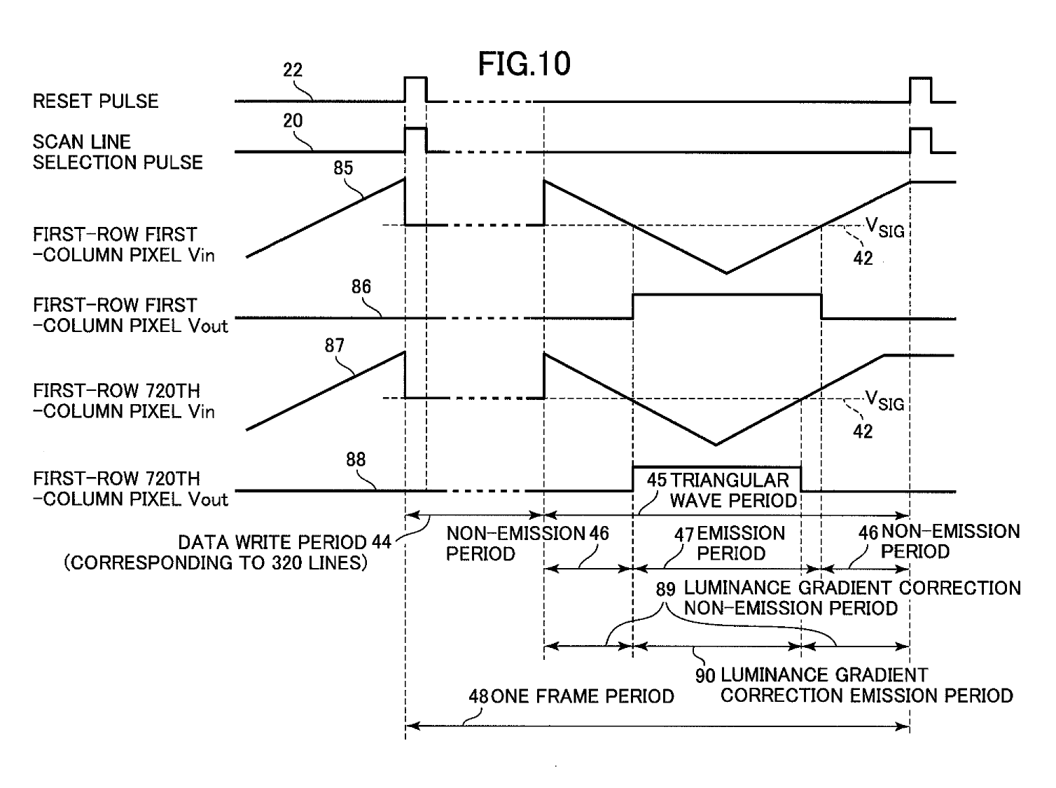

FIG. 9 illustrates operations of the frame storage means and retrace period output control internal data line drive means 9 illustrated in FIG. 5 and of the triangular wave data shift means 71 illustrated in FIG. 7. In FIG. 9, reference numeral 79 denotes a first-line triangular wave data start timing, 80 denotes a second-line triangular wave data start timing, 81 denotes first-line triangular wave serial data, 82 denotes second-line triangular wave serial data, 83 denotes 320th-line display data, and 84 denotes first-line triangular wave data. As in the case of the display data, the triangular wave serial data 59 is captured in synchronization with the triangular wave clock 58, based on a timing when the triangular wave start signal 57 is “1”. FIG. 9 illustrates that the one-line triangular wave data 74 is output as the one-line latch data 62 at the rising edge of the triangular wave lateral latch pulse 61 after all the data pieces corresponding to one line are captured. For example, the first-line triangular wave serial data 81 is output as the first-line triangular wave data 84 at the rising edge of the triangular wave lateral latch pulse 61 after the completion of capture of all the data pieces. A case where the time axis is extended in FIG. 9 is the same as in FIG. 8.

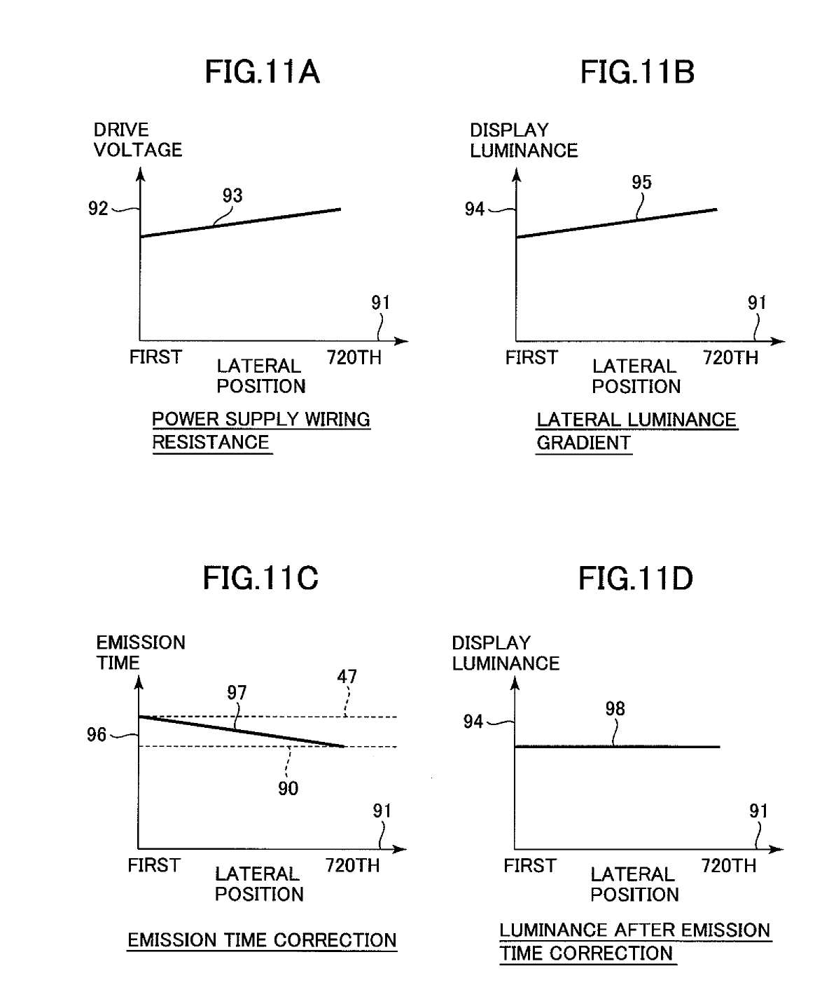

FIG. 10 illustrates a luminance gradient correction operation based on the triangular wave control during the signal voltage write operation and the turn-on time control operation performed by using the triangular wave. In FIG. 10, reference numeral 85 denotes a first-row first-column pixel inverter input, 86 denotes a first-row first-column pixel inverter output, 87 denotes a first-row 720th-column pixel inverter input, 88 denotes a first-row 720th-column pixel inverter output, 89 denotes a luminance gradient correction non-emission period, and 90 denotes a luminance gradient correction emission period. The first-row 720th-column pixel inverter output 88 is controlled so as to shorten the width of the triangular wave because a luminance increases with a shift to the right side of the panel. Therefore, the luminance gradient correction emission period 90 which is the emission period with respect to the same drive inverter threshold voltage 42 is shorter than the emission period 47, and hence the luminance gradient is eliminated.

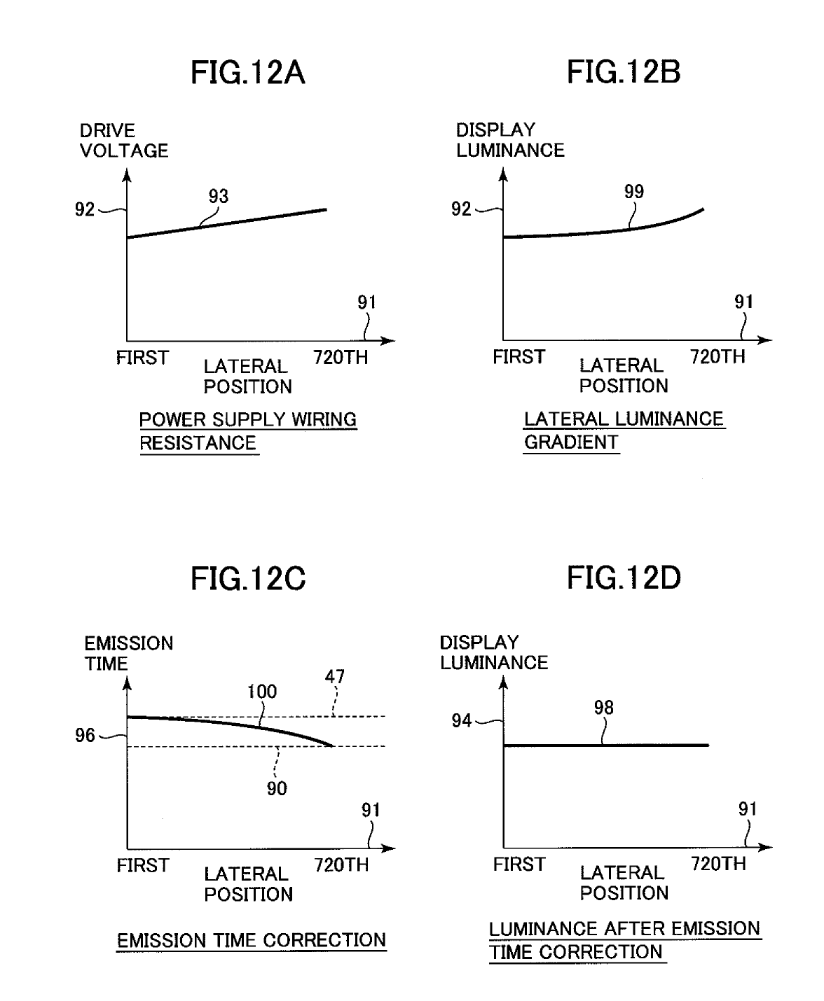

FIGS. 11A to 11D illustrate the concept of the luminance gradient correction during white display. Reference numeral 91 denotes a lateral position axis, 92 denotes a self-emission element drive voltage axis, and 93 denotes a drive voltage-lateral position characteristic. In the first embodiment of the present invention, the drive voltage-lateral position characteristic 93 exhibits that the drive voltage reduces with a shift to the left side. Reference numeral 94 denotes a display luminance axis and 95 denotes a display luminance-lateral position characteristic. In the first embodiment of the present invention, the display luminance-lateral position characteristic 95 exhibits that the display luminance reduces (luminance gradient) with the shift to the left side. Reference numeral 96 denotes an emission time axis and 97 denotes an emission time-lateral position characteristic. In the first embodiment of the present invention, the emission time-lateral position characteristic 97 exhibits that the emission time to be corrected so as to be lengthened with the shift to the left side. In the first embodiment of the present invention, a corrected display luminance-lateral position characteristic 98 exhibits a display luminance in a case where the emission time is corrected based on the emission time-lateral position characteristic 97, which means that the luminance gradient is eliminated.

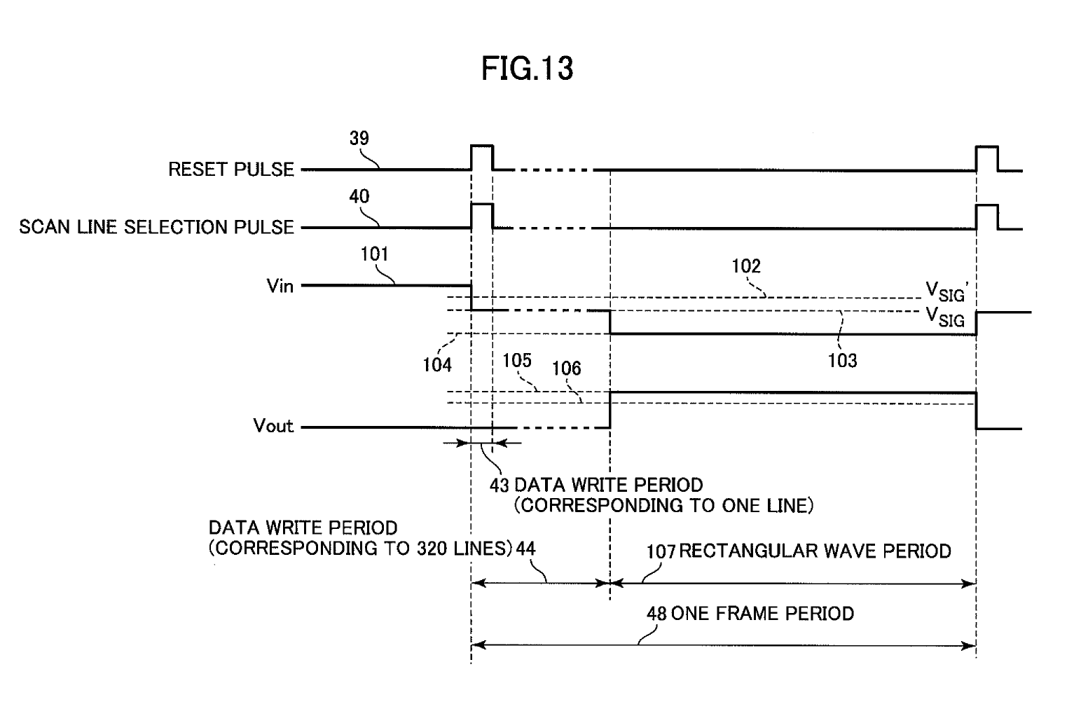

FIGS. 12A to 12D illustrate the concept of the luminance gradient correction during white display in a case where the luminance gradient characteristic is different (nonlinear). In the first embodiment of the present invention, a nonlinear display luminance-lateral position characteristic 99 exhibits that display luminance nonlinearly reduces (luminance gradient) with the shift to the left side. In the first embodiment of the present invention, a nonlinear emission time-lateral position characteristic 100 exhibits that the emission time is corrected so as to nonlinearly lengthen with the shift to the left side. As a result, the luminance gradient is eliminated as illustrated in the corrected display luminance-lateral position characteristic 98.

Hereinafter, the correction of the luminance gradient in the first embodiment of the present invention is described with reference to FIGS. 1 to 10, 11A to 11D, and 12A and 12D.

First, a flow of the display data is described with reference to FIG. 1. In FIG. 1, the display control section 6 generates the data line control signals 7 and the scan line control signals 8 based on the vertical synchronizing signal 1, the horizontal synchronizing signal 2, the data enable signal 3, the display data 4, and the synchronizing clock 5 in synchronization with the display timing of the self-emission element display 17. The frame storage means and retrace period output control internal data line drive means 9 stores the data line control signals 7 including 6-bit gradation information which correspond to one frame (which may correspond to a plurality of lines) and converts the stored data line control signals into the signal voltages for displaying the pixels of the self-emission element display 17. The frame storage means and retrace period output control internal data line drive means 9 generates, during a retrace period, the triangular waves so as to correct the luminance gradient, and outputs the generated triangular waves as the data line drive signals 10. The detailed description is given later. The scan line drive means 11 outputs the scan line drive signals 12 to sequentially select the scan lines of the self-emission element display 17. The pixel control means 13 generates the data write control signals 14 for controlling, for each scan line, the write control switches provided in the pixels of the self-emission element display 17. The detailed description is given later. The drive voltage generation means 15 generates the self-emission element drive voltage 16 for turning on the organic EL elements. The pixels on the scan line selected based on the scan line drive signals 12 and the data write control signals 14 in the self-emission element display 17 are turned on based on the signal voltages of the data line drive signals 10, the triangular wave signals, and the self-emission element drive voltage 16. The detailed description is given later.

The turn-on operation of the self-emission element display 17 illustrated in FIG. 1 is described in detail with reference to FIGS. 2 to 4. In FIG. 2, when the write control switch 34 is turned on through the first write control line 22, the input and output terminals of the drive inverter 33 are short-circuited, and hence the signal voltage write reference potential 38 becomes an intermediate potential between the input and output potentials of the drive inverter 33 based on the characteristic illustrated in FIG. 3. At this time, when the scan line selection voltage is supplied through the first scan line 20, the switching transistor 31 is turned on. The signal voltage of data from the first data line 18 is stored in the write capacitor 32 based on the signal voltage write reference potential 38, to thereby generate the drive inverter threshold voltage 42 illustrated in FIG. 4. In FIG. 2, when an input voltage exceeds the threshold voltage, the output of the drive inverter 33 is “0”. When the input voltage is smaller than the threshold voltage, the output of the drive inverter 33 is “1”. Therefore, as illustrated in FIG. 4, during the non-emission periods 46 in which the level of the triangular wave input through the first data line 18 exceeds the drive inverter threshold voltage 42, the output of the drive inverter 33 is “0”. During the emission period 47 in which the level of the triangular wave is smaller than the drive inverter threshold voltage 42, the output of the drive inverter 33 is “1”. In FIG. 2, when the output of the drive inverter 33 is “0”, the organic EL element 35 is in an off state. When the output of the drive inverter 33 is “1”, the organic EL element 35 is in an on state, and hence the organic EL element 35 emits light when the drive current corresponding to the self-emission element drive voltage 16 flows therethrough. As described above, the emission and non-emission are performed by the time control based on the signal voltage to realize gradation display. The drive inverter 33 is expressed by a logic circuit symbol and normally includes a CMOS transistor. The drive inverter 33 may be any inverter having the characteristic illustrated in FIG. 3.

The principles of generation and correction of the luminance gradient are described with reference to FIGS. 5, 11A to 11D, and 12A to 12D. In FIG. 5, the self-emission element drive voltage 16 is input from the right lower edge of the panel and the wiring resistance in the lateral direction is relatively large. As described earlier, the self-emission element display 17 emits light when currents flow into the organic EL elements 35, and hence the voltage drop on the left side of the panel is larger than the voltage drop on the right side thereof during white display because of the wiring resistances. Such a state is illustrated in FIG. 11A. The voltage drops cause the luminance gradient in which the luminance reduces from right to left in the lateral direction as illustrated in FIG. 11B. Therefore, when the emission time lengthens with the shift to the left side as illustrated in FIG. 11C, the luminance gradient is eliminated as illustrated in FIG. 11D. Note that, when the self-emission element drive voltage 16 is input from the left side of the panel and thus the direction of the voltage drop is reversed, the emission time may be lengthened with the shift to the right side, to thereby correct the luminance gradient.

The case where the state of the luminance gradient is different is illustrated in FIGS. 12A to 12D. As in the case of FIG. 11A to 11D, the self-emission element display 17 emits light when currents flow into the organic EL elements 35, and hence the voltage drop on the left side of the panel is larger than the voltage drop on the right side thereof during white display because of the wiring resistances. Such a state is illustrated in FIG. 12A. This is the same as FIG. 11A. The voltage drops cause the luminance gradient in which the luminance reduces from right to left in the lateral direction as illustrated in FIG. 12B. Therefore, the luminance gradient illustrated in FIG. 12B is nonlinear, which is different from the luminance gradient illustrated in FIG. 11B. In the case illustrated in FIG. 12B, the emission time is nonlinearly lengthened with the shift from right to left in the lateral direction as illustrated in FIG. 12C, and hence the luminance gradient is eliminated as illustrated in FIG. 12D. Note that, when the self-emission element drive voltage 16 is input from the left side of the panel and thus the direction of the voltage drop is reversed, the emission time may be lengthened with the shift to the right side, to thereby correct the luminance gradient.

The operation for correcting the luminance gradient based on the triangular waves output from the frame storage means and retrace period output control internal data line drive means 9 during the retrace period is described in detail with reference to FIGS. 6 to 10, 11A to 11D, and 12A and 12D.

In FIG. 6, the frame storage and triangular wave data latch means 53 captures the display input serial data 56 based on the data start signal 54 and the data clock 55. The frame storage and triangular wave data latch means 53 collects data pieces corresponding to the respective lateral lines to read out data corresponding to 320 lines in synchronization with the lateral data readout pulse 60, and outputs the resultant data as the one-line data 62. The frame storage and triangular wave data latch means 53 captures the triangular wave serial data 59 based on the triangular wave start signal 57 and the triangular wave clock 58, and successively outputs, as the one-line data 62, the triangular signals corresponding to one lateral line in synchronization with the triangular wave lateral latch pulse 61. The detailed description is given later.

The data accumulation means 63 identifies the display luminance at each lateral position and accumulates the display luminance from the frame edge. The voltage drop of the self-emission element drive voltage 16 and the luminance gradient from an input portion in the lateral direction may be estimated based on a result obtained by accumulation, and hence the data accumulation means 63 outputs such information as the luminance gradient information 64. For example, in the case of white display, the result obtained by accumulation is a linear line rising from right to left, and hence the luminance gradient as illustrated in FIG. 11B is predicted. In contrast to this, the voltage drop does not occur during black display, and hence the absence of the luminance gradient is predicted, such information is output as the luminance gradient information 64. The triangular wave data generation means 65 generates the triangular wave serial data 59 to control the emission time for eliminating the luminance gradient, based on the luminance gradient information 64. For example, in the case of the luminance gradient illustrated in FIG. 11B, the triangular wave data generation means 65 generates the triangular wave serial data 59 to provide the emission time with the gradient illustrated in FIG. 11C. In other words, as illustrated in FIG. 10, the triangular wave data generation means 65 generates a triangular wave having a period shortened with the shift to the right side in the lateral direction, to thereby eliminate the luminance gradient. In the first embodiment of the present invention, the period of the rectangular wave is controlled to control the luminance. When the luminance may be provided with the gradient opposite to the predicted luminance gradient (by controlling, for example, emission intensity), the period of the triangular wave is not necessarily controlled.

In the case of the luminance gradient illustrated as FIG. 12B, the triangular wave data generation means 65 provides the emission time with the gradient as illustrated in FIG. 12C. In other words, as illustrated in FIG. 10, the triangular wave data generation means 65 generates a triangular wave having a period lengthened with the shift to the left side in the lateral direction, to thereby eliminate the luminance gradient. In this case, the period of the triangular wave is nonlinearly lengthened with the shift to the left side in the lateral direction, to thereby eliminate the luminance gradient. In the first embodiment of the present invention, the period of the rectangular wave is controlled, to thereby control the luminance. When the luminance may be provided with the gradient opposite to the predicted luminance gradient (by controlling, for example, emission intensity), the period of the triangular wave is not necessarily controlled.

The lateral output control means 67 counts the lateral output timing 66 which is the drive timing of the self-emission element display 17. Therefore, the lateral output control means 67 generates the lateral data readout pulse 60 during the display data output period, and generates the triangular wave lateral latch pulse 61 during the triangular wave output period. The detailed description is given later. As in the conventional case, the gradation voltage selection means 68 selects a gradation voltage having one of 64 gradation levels, based on the one-line latch data 62 having 6 bits and outputs the selected gradation voltage as the one-line display data 70.

The operation in the case where the frame storage and triangular wave data latch means 53 outputs both the display data and the triangular waves as the one-line data 62 is described in detail with reference to FIGS. 7 to 9. In FIG. 7, the frame storage means 69 temporarily stores the display input serial data 56 corresponding to one frame, based on the data start signal 54 and the data clock 55, and reads out the stored display input serial data in synchronization with the lateral data readout pulse 60. Then, the frame storage means 69 outputs the read out data, as the one-line display data 70. In FIG. 8, the lateral output timing 66 has a frequency two times larger than the frequency of the data start signal 54 corresponding to a data capture timing. The lateral data readout pulse 60 has the same frequency as the lateral output timing, and output as a pulse corresponding to 320 lines. In the first embodiment of the present invention, the frame storage means 69 stores the display input serial data 56 corresponding to one frame and reads out the stored display input serial data at double speed. Data corresponding to a plurality of lines may be stored and read out at high speed (which is not limited to double speed). In the first embodiment of the present invention, the frame storage means 69 is used to lengthen the retrace period and thus may be omitted in a case where the retrace period of the input timing is sufficiently long.

In FIG. 7, the triangular wave data shift means 71 latches the triangular wave serial data 59 based on the triangular wave start signal 57 and the triangular wave clock 58, and outputs the latched triangular wave serial data as the triangular wave shift data 72. As illustrated in FIG. 9, the triangular wave data shift means 71 captures the triangular wave serial data 59 at the rising edge of the triangular wave clock 58, based on the triangular wave start signal 57 used as the capture start reference.

In FIG. 7, the triangular wave line latch means 73 latches the triangular wave shift data 72 captured by the triangular wave data shift means 71 in synchronization with the triangular wave lateral latch pulse 61, and outputs the latched triangular wave shift data as the one-line triangular wave data 74. As illustrated in FIG. 9, the one-line triangular wave data 74 is output at the rising timing of the triangular wave lateral latch pulse 61. FIG. 9 illustrates that a value of the one-line triangular wave data 74 is decremented one by one for each line from 63 which is a maximum value of 6-bit data, and incremented one by one to reach 63 again after the value reaches a minimum value of 0, that is, the one-line triangular wave data 74 is output during a period corresponding to 127 lines. The luminance gradient correction described earlier is performed by controlling the period for each data line. In FIG. 7, the one-line display data 70 and the one-line triangular wave data 74 are combined, and output as the one-line data 62 as illustrated in FIGS. 8 and 9.

As described above, according to the display device according to the first embodiment of the present invention, the data line drive signals 10 during the retrace period are controlled by the frame storage means and retrace period output control internal data line drive means 9, without depending on input display data input from an external system or the like, and hence the voltage during the retrace period (triangular wave in first embodiment of the present invention) is controlled for each data line. Therefore, such an effect is obtained that the luminance gradient in the lateral direction, that is, the arrangement direction of the organic EL drive voltage supply lines 24 and 25, which results from the relatively high resistance in the wiring for the self-emission element drive voltage 16, is eliminated by controlling the emission time for each data line. As a result, there may be provided a display device capable of correcting the luminance gradient in the lateral direction which depends on the display state, without using an additional external circuit such as a power supply for correcting the luminance gradient.

### Second Embodiment

Hereinafter, a second embodiment of the present invention is described in detail with reference to the accompanying drawings.

In the second embodiment, a rectangular wave is used instead of the triangular wave for the gradation control described in the first embodiment. The writing of the display data is the same as in the first embodiment. Hereinafter, different parts are mainly described.

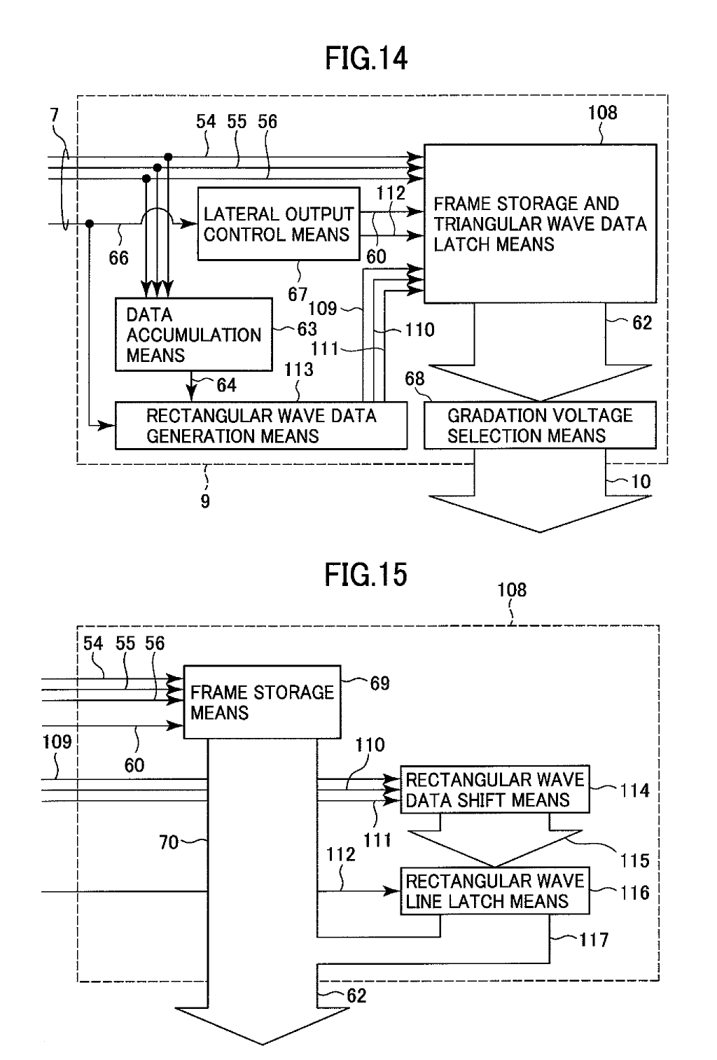

FIG. 13 illustrates a signal voltage write operation and a turn-on time control operation performed by using a rectangular wave level. Reference numeral 101 denotes a drive inverter rectangular wave input, 102 denotes a high-gradation signal voltage, 103 denotes a low-gradation signal voltage, 104 denotes a rectangular wave reference level, 105 denotes a high-gradation emission level, 106 denotes a low-gradation emission level, and 107 denotes a rectangular wave period. The write control pulse 39 is used to turn on the write control switch 34 illustrated in FIG. 2, to thereby set the signal voltage write reference voltage 38 illustrated in FIG. 3. The scan line selection pulse 40 is used to turn on the switching transistor 31 illustrated in FIG. 2 simultaneously with the turn-on of the write control switch 34 based on the write control pulse 39, to thereby write the signal voltage into the write capacitor 32 through the drive inverter rectangular wave input 101, based on the signal voltage write reference voltage 38. As a result, when a signal voltage having a bright gradation is to be written, the high-gradation signal voltage 102 (V_{SIG}′) is a threshold voltage of the drive inverter 33. When a signal voltage having a dark gradation is to be written, a low write signal voltage V_{SIG} is a threshold voltage of the drive inverter 33.

The drive inverter rectangular wave input 101 exhibits an input waveform of a certain drive inverter. Each of the other drive inverters provided on the same scan line also receives an input of a signal voltage based on display data at a corresponding position within a period of the data write period 43 corresponding to one line. Signal voltages for the other scan lines are written during the other periods of the data write period 44. After the completion of the data write period 44, the drive inverter rectangular wave input 101 is set to the rectangular wave reference level 104 during the rectangular wave period 107. Therefore, unlike the first embodiment, an ON current corresponding to a difference between the write voltage and the rectangular wave reference level 104 may be caused to flow into the drive inverter 33. In the case of bright gradation, light emission is performed at the high-gradation emission level 105. In the case of dark gradation, light emission is performed at the low-gradation emission level 106. The light emission is not necessarily performed during the emission time. Thus, the emission level (intensity) based on the signal voltage is determined. Note that the data input and the rectangular wave input are performed at predetermined intervals. The second embodiment of the present invention described below is based on the assumption that the data input and the rectangular wave input are performed during the one frame period 48 corresponding to a frequency of 60 [Hz].

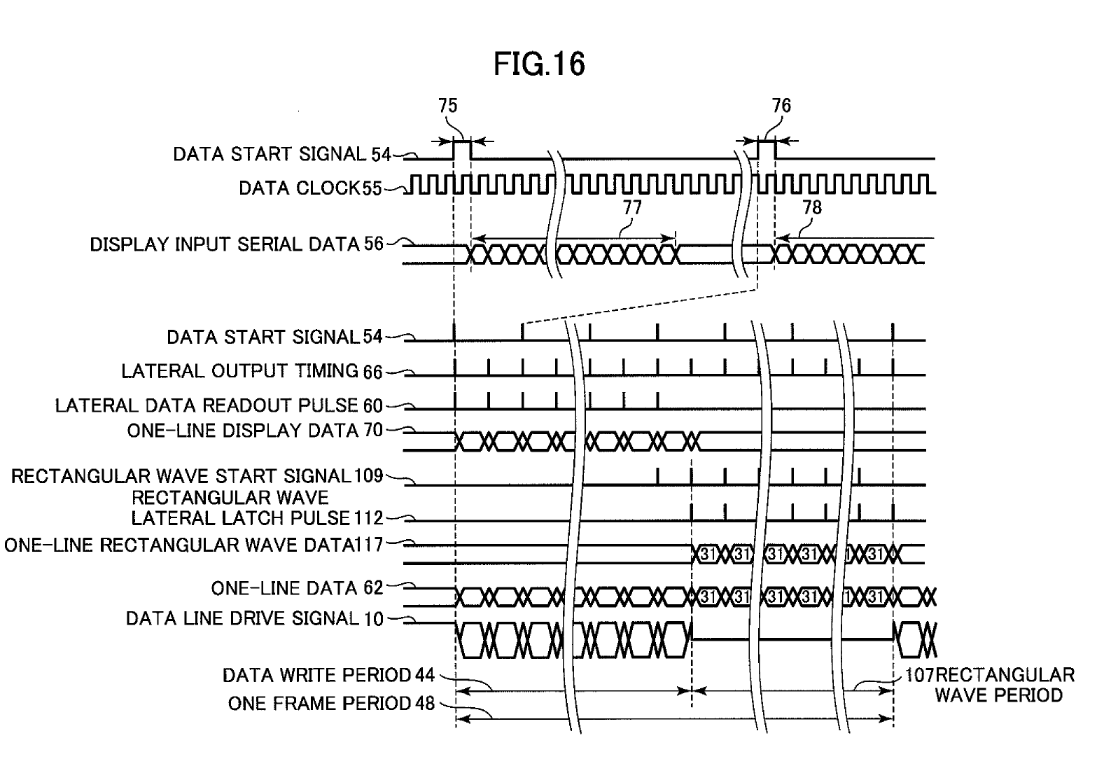

FIG. 14 illustrates an example of an internal structure of frame storage means and retrace period output control internal data line drive means 9 in a self-emission element display device according to the second embodiment of the present invention. In FIG. 14, reference numeral 108 denotes frame storage and rectangular wave data latch means, 109 denotes a rectangular wave start signal, 110 denotes a rectangular wave clock, 111 denotes a rectangular wave serial data, and 112 denotes a rectangular wave lateral latch pulse.

As in the first embodiment, the frame storage and rectangular wave data latch means 108 operates in synchronization with the data clock 55, and captures the display input serial data 56 corresponding to one line during one horizontal period based on the data start signal 54 used as a capture start reference. Then, the frame storage and rectangular wave data latch means 108 causes storage means (described later) to temporarily store the captured display input serial data 56 corresponding to one line, and collectively reads out one-line display data pieces (described later in detail) corresponding to one lateral line in synchronization with the lateral data readout pulse 60. The frame storage and rectangular wave data latch means 108 operates in synchronization with the rectangular wave clock 110, captures the rectangular wave serial data 111 corresponding to one line during one horizontal period based on the rectangular wave start signal 109 used as the capture start reference, and outputs one-line rectangular wave data (described later in detail) in synchronization with the rectangular wave lateral latch pulse 112. Then, the frame storage and rectangular wave data latch means 108 combines the one-line display data pieces corresponding to one lateral line which are collectively read out in synchronization with the lateral data readout pulse 60 and the one-line rectangular wave data output in synchronization with the rectangular wave lateral latch pulse 112, and outputs the resultant data as the one-line data 62.

The operation of the data accumulation means 63 is the same as in the first embodiment.

Reference numeral 113 denotes rectangular wave data generation means. The rectangular wave data generation means 113 counts the lateral output timing 66 to identify a rectangular wave output timing, and then generates the rectangular wave start signal 109, the rectangular wave clock 110, and the rectangular wave serial data 111. In this case, the rectangular wave data generation means 113 generates a rectangular wave reference level with a gradient opposite to the luminance gradient information 64 based on the lateral position and the luminance gradient information 64. The operations of the lateral output control means 67 and the gradation voltage selection means 68 are the same as in the first embodiment. The timings are the same as in the first embodiment, but the second embodiment of the present invention is different from the first embodiment in that the rectangular wave serial data 111 indicating the rectangular wave is used instead of the triangular wave serial data 59 which is the digital data indicating the triangular wave. Therefore, the frame storage and rectangular wave data latch means 108 is identical to the frame storage and triangular wave data latch means 53, though the names thereof are different from each other.

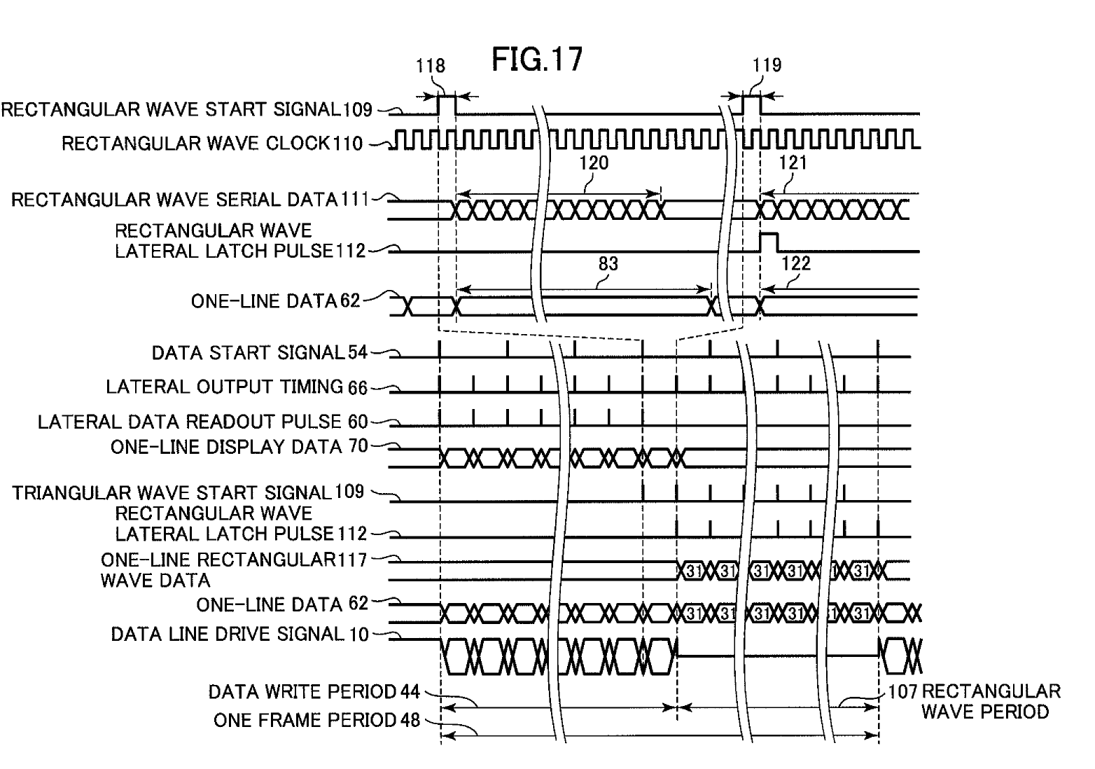

FIG. 15 illustrates an example of an internal structure of the frame storage and rectangular wave data latch means 108 illustrated in FIG. 14. In FIG. 15, the operation of the frame storage means 69 is the same as in the first embodiment. Reference numeral 114 denotes rectangular wave data shift means and 115 denotes rectangular wave shift data. The rectangular wave data shift means 114 operates in synchronization with the rectangular wave clock 110 and captures the rectangular wave serial data 111 corresponding to one line during one horizontal period based on the rectangular wave start signal 109 used as the capture start reference. The captured rectangular wave serial data is output as the rectangular wave shift data 115.

Reference numeral 116 denotes rectangular wave line latch means and 117 denotes one-line rectangular wave data. The rectangular wave line latch means 116 latches the rectangular wave shift data 115 corresponding to one line and outputs the latched rectangular wave shift data as the one-line rectangular wave data 117 in synchronization with the rectangular wave lateral latch pulse 112. The one-line display data 70 and the one-line rectangular wave data 117 are combined for each output data line and output as the one-line data 62. In other words, in the second embodiment of the present invention, the display data output period is not overlapped with the rectangular wave output period (described later in detail).

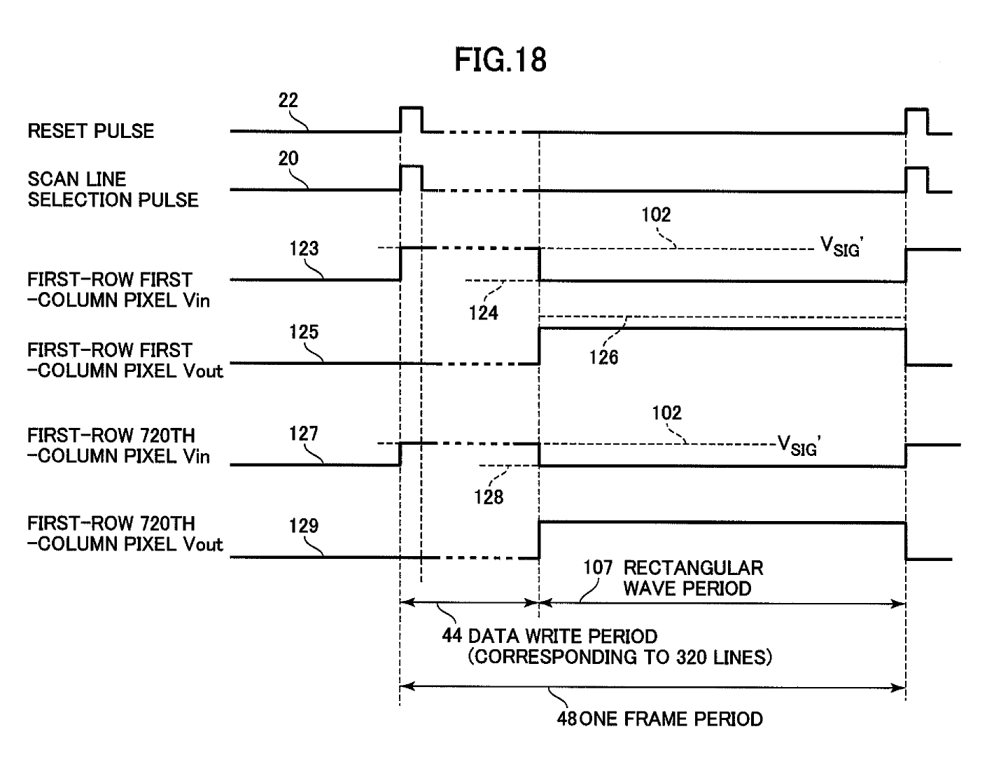

FIG. 16 illustrates operations of the frame storage means and retrace period output control internal data line drive means, of the frame storage means 69, and of the rectangular wave line latch means 116 in the self-emission element display device according to the second embodiment of the present invention. In FIG. 15, the display input serial data 56 is captured in synchronization with the data clock 55 based on a timing when the data start signal 54 is “1” and temporarily stored in the frame storage means described above. For example, the n-th-line display input serial data 77 is captured from the rising edge of the data clock 55 which follows the n-th-line data start timing 75 and temporarily stored in the frame storage means. FIG. 16 also illustrates the time axis which is extended. The temporarily-stored display input serial data pieces corresponding to one lateral line are collectively read out in synchronization with the lateral data readout pulse 60 within the data write period 44. The second embodiment of the present invention described below is based on the assumption that, in order to shorten the data write period and lengthen the rectangular wave period 107, display data pieces corresponding to one frame are temporarily stored such that the lateral data readout pulse 60 which is a readout timing is higher in frequency (two times higher in this embodiment) than the data start signal 54. The points described above are the same as in the first embodiment.

The rectangular wave start signal 109 is output during the rectangular wave period 107 which starts at the same timing as the final lateral data readout pulse 60 and is obtained by subtracting the data write period 44 from the one frame period 48. The rectangular wave lateral latch pulse 112 is output for a line next to a line for which the rectangular wave start signal 109 starts to be output. Therefore, the one-line display data 70 is output as the one-line data 62 during the data write period 44. The one-line rectangular wave data 117 is output as the one-line data 62 during the rectangular wave period 107. The data line drive signal 10 is obtained by performing analog conversion on the one-line data 62. The second embodiment is different from the first embodiment in that the data line drive signal 10 does not have the triangular wave but a predetermined level (“31” is set in second embodiment, but the present invention is not limited to “31”) during the rectangular wave period 107. The other points are the same as in the first embodiment.

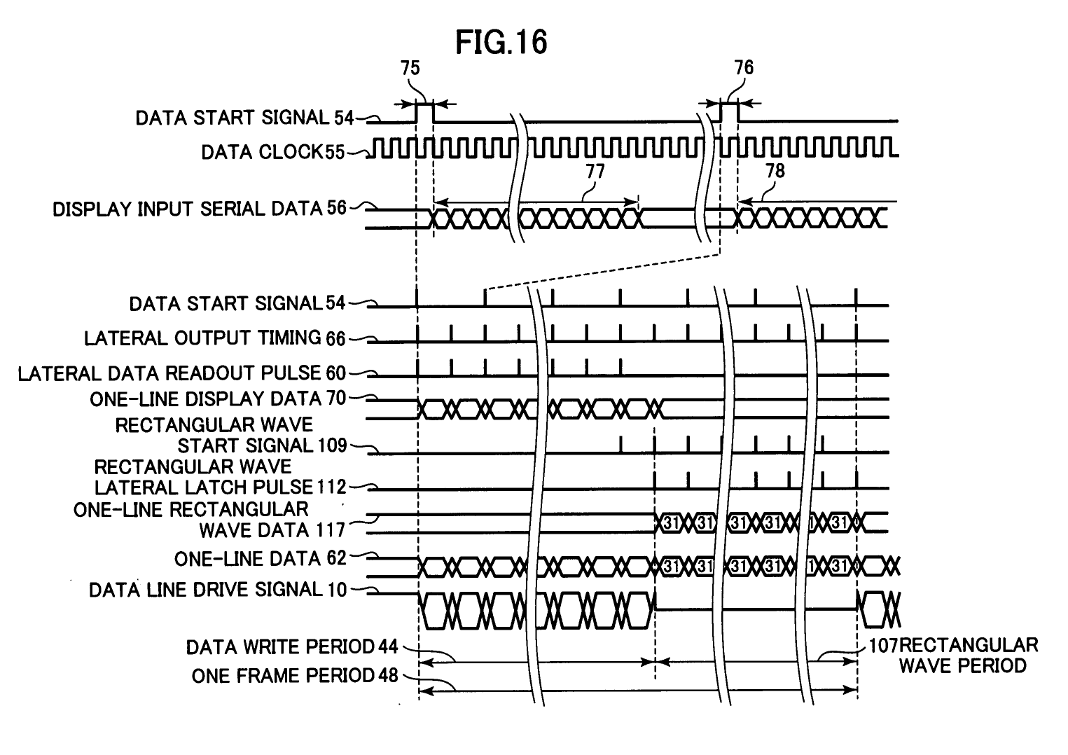

FIG. 17 illustrates operations of the frame storage means and retrace period output control internal data line drive means and of the rectangular wave data shift means 114 illustrated in FIG. 15 in the self-emission element display device according to the second embodiment of the present invention. In FIG. 17, reference numeral 118 denotes a first-line rectangular wave data start timing, 119 denotes a second-line rectangular wave data start timing, 120 denotes first-line rectangular wave serial data, 121 denotes second-line rectangular wave serial data, and 122 denotes first-line rectangular wave latch data. As in the case of the display data, the rectangular wave serial data 111 is captured in synchronization with the rectangular wave clock 110 based on a timing when the rectangular wave start signal 109 is “1”. FIG. 17 illustrates that the one-line rectangular wave data 117 is output as the one-line data 62 at the rising edge of the rectangular wave lateral latch pulse 112 after all the data pieces corresponding to one line are captured. For example, the first-line rectangular wave serial data 120 is output as the first-line rectangular wave latch data 122 at the rising edge of the rectangular wave lateral latch pulse 112 after the completion of capture of all the data pieces. A case where the time axis is extended in FIG. 17 is the same as in FIG. 16.

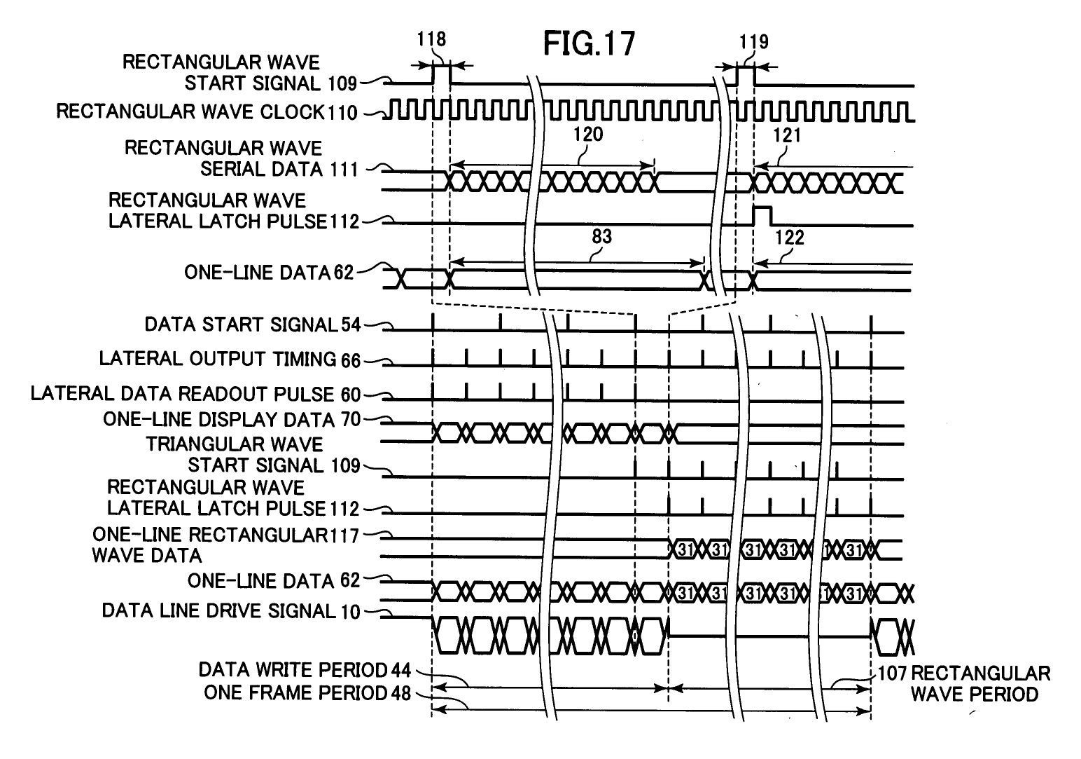

FIG. 18 illustrates a luminance gradient correction operation based on the rectangular wave control during the signal voltage write operation and the turn-on time control operation performed by using the rectangular wave. In FIG. 18, reference numeral 123 denotes a first-row first-column pixel inverter rectangular wave input, 124 denotes a first-column pixel rectangular wave reference level, 125 denotes a first-row first-column pixel inverter rectangular wave output, 126 denotes a first-row first-column pixel inverter rectangular wave output with no luminance gradient, 127 denotes a first-row 720th-column pixel inverter rectangular wave input, 128 denotes a 720th-column pixel rectangular wave reference level, and 129 denotes a first-row 720th-column pixel inverter rectangular wave output. The first-row first-column pixel inverter rectangular wave output 125 is controlled such that the first-column pixel rectangular wave reference level 124 is lower than the 720th-column pixel rectangular wave reference level 128, because the luminance reduces with the shift to the left side of the panel. Therefore, an emission intensity with respect to the same high-gradation signal voltage (V_{SIG}′) 102 appears to become higher as indicated by the first-row first-column pixel inverter rectangular wave output with no luminance gradient 126. However, an actual emission intensity becomes lower because of the luminance gradient as indicated by the first-row first-column pixel inverter rectangular wave output 125. As a result, the emission intensity becomes equal to an emission intensity corresponding to the first-row 720th-column pixel inverter rectangular wave output 129, and hence the luminance gradient is eliminated.

As described above, according to the display device according to the second embodiment of the present invention, the data line drive signals 10 during the retrace period are controlled by the frame storage means and retrace period output control internal data line drive means 9, without depending on input display data input from an external system or the like, and hence the voltage during the retrace period (rectangular wave in second embodiment of the present invention) is controlled for each data line. Therefore, such an effect is obtained that the luminance gradient in the lateral direction, that is, the arrangement direction of the organic EL drive voltage supply lines 24 and 25, which results from the relatively high resistance in the wiring for the self-emission element drive voltage 16, is eliminated by controlling the emission intensity for each data line. As a result, there may be provided a display device capable of correcting the luminance gradient in the lateral direction which depends on the display state, without using an additional external circuit such as a power supply for correcting the luminance gradient.

As described above, according to the display device in each of the embodiments of the present invention, the emission reference signal supplied from the data line drive means is varied for each data line, and hence the emission time in the arrangement direction of the data lines may be freely controlled (gradient is provided in arrangement direction of data lines). According to the display device in each of the embodiments of the present invention, the luminance gradient is predicted based on the result of the accumulated amount of light emission which is detected by the means for detecting the accumulated amount of light emission in the arrangement direction of the data lines, and the emission time (gradient) is controlled such that the emission time is provided with a gradient for eliminating the luminance gradient. Thus, the luminance gradient in the lateral direction which depends on the display state may be corrected, without using an additional external circuit such as a power supply for correcting the luminance gradient.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device, comprising:
a plurality of display elements arranged in matrix;
a plurality of data lines for supplying display signal voltages to the plurality of display elements;
a plurality of scan lines intersecting with the plurality of data lines;
a plurality of power supply lines intersecting with the plurality of scan lines;
a data line drive circuit for outputting emission control voltages for controlling light emission of the plurality of display elements during a retrace period during which the display signal voltages are not output; and
an emission power supply circuit for supplying power supply voltages for the light emission of the plurality of display elements to the plurality of power supply lines from at least one of external sides of a display region corresponding to a group including the plurality of display elements,
wherein the data line drive circuit generates and outputs the emission control voltages different among the plurality of data lines.

2. A display device according to claim 1, wherein the emission control voltages comprise a triangular wave.

3. A display device according to claim 1, wherein the emission control voltages, which are generated by the data line drive circuit for the plurality of data lines, are controlled so that emission intensities of the plurality of display elements are provided with a gradient in an arrangement direction of the plurality of power supply lines.

4. A display device according to claim 2, wherein the triangular wave of the emission control voltages, which are generated by the data line drive circuit for the plurality of data lines, has a width controlled so that emission intensities of the plurality of display elements are provided with a gradient in an arrangement direction of the plurality of power supply lines.

5. A display device according to claim 3, wherein the gradient of the emission intensities of the plurality of display elements has a direction for eliminating a voltage drop of the plurality of power supply lines.

6. A display device according to claim 1, wherein the data line drive circuit comprises means for identifying a luminance gradient based on input display data.

7. A display device, comprising:
a plurality of display elements arranged in matrix;
a plurality of data lines for supplying display signal voltages to the plurality of display elements;
a plurality of scan lines intersecting with the plurality of data lines;
a plurality of power supply lines intersecting with the plurality of scan lines;
a data line drive circuit for outputting emission control voltages for controlling light emission of the plurality of display elements during a retrace period during which the display signal voltages are not output; and
an emission power supply circuit for supplying power supply voltages for the light emission of the plurality of display elements to the plurality of power supply lines from at least one of external sides of a display region corresponding to a group including the plurality of display elements,
wherein the data line drive circuit generates and outputs the emission control voltages which are emission control voltages for eliminating a luminance gradient of the plurality of display elements in an arrangement direction of the plurality of power supply lines and which are different among the plurality of data lines.

8. A display device according to claim 7, wherein the emission control voltages comprise a triangular wave.

9. A display device according to claim 8, wherein the triangular wave of the emission control voltages, which are generated by the data line drive circuit for the plurality of data lines, has a width controlled so that emission intensities of the plurality of display elements are provided with a gradient in the arrangement direction of the plurality of power supply lines.

10. A display device according to claim 7, wherein the data line drive circuit comprises means for identifying the luminance gradient based on input display data.

11. A display device, comprising:
a plurality of display elements arranged in matrix;
a plurality of data lines for supplying display signal voltages to the plurality of display elements;
a plurality of scan lines intersecting with the plurality of data lines;
a plurality of power supply lines intersecting with the plurality of scan lines;
a data line drive circuit for outputting emission control voltages for controlling light emission of the plurality of display elements during a retrace period during which the display signal voltages are not output;
an emission power supply circuit for supplying power supply voltages for the light emission of the plurality of display elements to the plurality of power supply lines from at least one of external sides of a display region corresponding to a group including the plurality of display elements; and
luminance gradient identification means for identifying a luminance gradient caused by a voltage drop of the plurality of power supply lines,
wherein the data line drive circuit generates and outputs the emission control voltages different among the plurality of data lines so as to eliminate the luminance gradient of the plurality of display elements, which is identified by the luminance gradient identification means.

12. A display device according to claim 11, wherein the emission control voltages comprise a triangular wave.

13. A display device according to claim 12, wherein the triangular wave of the emission control voltages, which are generated by the data line drive circuit for the plurality of data lines, has a width controlled so that emission intensities of the plurality of display elements are provided with a gradient in an arrangement direction of the plurality of power supply lines.

14. A display device according to claim 11, wherein the luminance gradient identification means identifies the luminance gradient in an arrangement direction of the plurality of power supply lines based on input display data.
